(19) United States
(12) Patent Application Publication
(10) Pub. No.: US 2016/0332908 A1
(43) Pub. Date: Nov. 17, 2016

(54) TEXTURED AR WITH PROTECTIVE THIN FILM

(71) Applicant: Intevac, Inc., Santa Clara, CA (US)

(72) Inventors: Terry Bluck, Santa Clara, CA (US); Babak Adibi, Los Altos, CA (US)

(21) Appl. No.: 15/152,488

(22) Filed: May 11, 2016

Related U.S. Application Data
(60) Provisional application No. 62/161,840, filed on May 14, 2015.

(51) Int. Cl. C03C 17/34; C03C 17/42

(52) U.S. Cl. CPC C03C 17/3441; C03C 17/3435; C03C 17/42; C03C 2217/281; C03C 2217/28; C03C 2217/40; C03C 2217/73; C03C 2217/76; C03C 2218/154

(57) ABSTRACT

A glass cover for electronic devices, the glass cover having a first coating formed directly over and in contact with the front surface of the glass (where front means the surface facing the user), the first coating is textured, and a second coating is provided over the first coating, the second coating being resistance to scratching, e.g., a DLC coating. The first coating may be made of, e.g., silicon-oxide, silicon-nitride, or silicon oxy-nitride.

### RELATED APPLICATIONS

This application claims priority benefit from U.S. Provisional Patent Application Ser. No. 62/161,840, filed on May 14, 2015, the disclosure of which is incorporated herein by reference in its entirety.

### BACKGROUND

1. Field

This disclosure relates to incorporating an anti-reflection property to glass substrates, particularly glass used for electronic devices, such as touch screens.

2. Related Art

Anti-reflection property is desired and has been implemented in many applications. For example, anti-reflection coating (ARC) is traditionally applied to prescription spectacles. The problem with anti-reflection coatings is that they are usually easily scratched. To overcome the scratching problem, a second coating is provided over the ARC, having hard surface that resists scratching. One type of such hard coating is hydrogenated diamond-like carbon, generally referred to in the industry as DLC. However, the introduction of DLC leads to another problem—sometimes referred to as the eggshell problem. That is, since the hard DLC coating is formed over a relatively soft ARC, it cracks upon application of load, much like an eggshell cracks upon application of load. Glasses are subjected to standardized Ball Drop Impact Resistance tests to determine their susceptibility to cracking upon application of load.

Another form of anti-reflection has been used by the solar industry. In order to increase the light absorption of solar cells, the surface of the cell's substrate is textured, generally in the shape of microscopic pyramids. Texturing has been also suggested for glass substrates used for electronic devices, such as mobile phones and tables. However, these devices utilize treated glass, such as, e.g., Gorilla Glass®. Texturing the surface of such glasses changes the mechanical properties of such glasses, making them more susceptible to breakage. Therefore, a solution is needed in the industry for providing anti-reflection property to glass of mobile devices, without compromising the resistance to scratching or reducing the mechanical properties of such glasses.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Embodiments of the invention provide a glass coating that incorporates anti-reflective and anti-finger printing properties, and is also resistance to scratches.

Various embodiments provide methods for forming the glass coating, and the resulting improved glass for electronic devices, such as touch screens.

Other embodiments provide a system for fabricating glass for electronic devices, having anti-reflective, scratch resistance, and hydrophobic properties, without removing the glass from vacuum environment between the various production steps.

Aspects of the invention involve a method for fabricating a cover glass for electronic devices, the cover glass having anti-reflective property, the method comprising cleaning the front surface of the glass, depositing a silicon-based coating directly on the front surface of the glass, texturing the front surface of the silicon-based coating, and forming a diamond-like coating over the silicon based coating. The method may also include a step of cleaning the silicon based coating after texturing the silicon based coating. The method may further include a step of hardening the silicon based coating after texturing, but before depositing the DLC coating. The hardening may include ion implant into the silicon-based coating, or depositing a layer comprising silicon and nitrogen over the textured surface of the silicon based coating. In such a case the silicon-based coating may be silicon dioxide. The method may further comprise forming an anti-finger printing layer over the DLC layer.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic of the improved glass coating according to one embodiment;

FIG. 2 is a schematic of a system for forming the glass coating, according to one embodiment;

FIG. 3 is a flow chart illustrating embodiments of various processes for fabricating the coated glass;

FIG. 4 is a schematic of the glass patterning according to one embodiment;

FIG. 5 is a schematic of the improved glass coating according to another embodiment.

### DETAILED DESCRIPTION

Embodiments of the invention provide glass that can be used in mobile devices, wherein the glass has anti-reflective property and is scratch resistance. Embodiments of the invention can be implemented using treated or untreated glass. For example, embodiments of the invention can be implemented using Gorilla Glass®.

Embodiments of the invention provide a glass cover for electronic devices, the glass cover having a first coating formed directly over and in contact with the front surface of the glass (where front means the surface facing the user), the first coating is textured, and a second coating is provided over the first coating, the second coating being resistance to scratching, e.g., a DLC coating. The first coating may be made of, e.g., silicon-oxide, silicon-nitride, or silicon oxy-nitride. The first coating may be of thickness from 100 nm to 500 nm.

Embodiments of the invention also provide methods for making anti-reflective and scratch resistance glass cover for electronic devices. One example of a method for producing the glass cover includes the steps of: cleaning a glass substrate, depositing a first coating layer directly on the front surface of the glass, texturizing the front surface of the first coating, and depositing a second coating on top of the textured surface of the first coating. The second coating is made of hard material, such as DLC. The first coating may be made of e.g., silicon-oxide, silicon-nitride, or silicon oxy-nitride. In one embodiment the first layer is made of silicon dioxide (SiO2), is textured, and is then implanted with nitrogen for improved hardness of the first layer. In one embodiment the first coating is textured by reactive ion etching using gasses such as, e.g., CF4 or CHF3, optionally with the addition of argon gas. In another embodiment the first layer is textured by patterning.

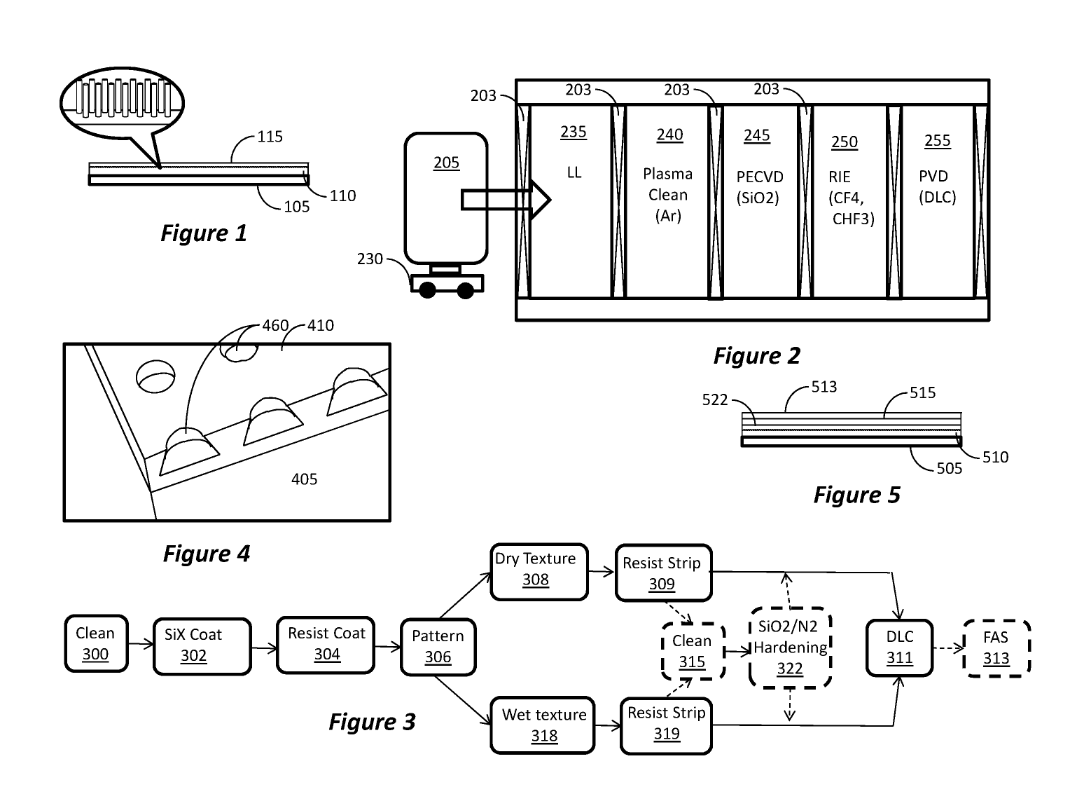

A specific embodiment will now be described with reference to FIG. 1. In FIG. 1 a glass substrate 105 may be treated or untreated. The front surface of the glass is defined as the surface facing the user when the glass is installed in an electronic device, such as a mobile phone, tables, laptop, etc. After the front surface is cleaned, a transparent layer 110 is deposited directly over the front surface of the glass. Transparent layer 110 may be e.g., silicon-dioxide, silicon-nitride, or silicon oxy-nitride, which can be deposited using, e.g., chemical vapor deposition, plasma enhanced chemical vapor deposition, etc. Gases such as silane, oxygen, and/or nitrogen may be used to deposit layer 110. The front surface of layer 110 (which is again the surface facing the user) is then texturized. The texturization may be random or patterned. If needed, the front surface of layer 110 may then be cleaned. This texturization process forms the anti-reflective coating (ARC) over the glass substrate. Thereafter, to provide anti-scratch property, a DLC layer 115 is formed over the textured surface of layer 110. The DLC layer may be formed using any standard technique, such as physical vapor deposition.

FIG. 2 illustrates a system according to one embodiment, enabling fabrication of the coated glass without removing the glass from vacuum environment between the various production steps. The various chambers of the system are isolated from each other using valves 203. The glass substrate 205 may be held by a carrier 230, which transports the glass throughout the system. The entrance to the system is via loadlock 235. In some embodiments carrier 230 never leaves the vacuum environment, and the glass substrate 205 is loaded onto carrier 230 only after it enters loadlock 235. This prevents exposing the carriers to contamination from atmospheric environment.

The system illustrated in FIG. 2 includes an optional cleaning chamber 240 for cleaning and/or conditioning the front surface of glass substrate 205. Chamber 240 may be implemented as a plasma chamber with argon gas. The plasma contacts the front surface of glass substrate 205 and conditions it for the next step. Next, the glass substrate 205 is transported to chamber 245 for forming the first transparent layer 210. Chamber 245 may be a CVD, a PECVD, etc., and uses a combination of gases selected from, e.g., silane, oxygen, nitrogen, argon, etc. In one embodiment, a combination of silane, oxygen and argon gases are utilized to form a silicon dioxide layer 110 over the front surface of glass substrate 205. While silicon dioxide is not resistive to scratching, it is easier to texturize than silicon nitride or silicon oxy-nitride.

Once layer 210 is formed, the glass substrate 205 is transferred to chamber 250 for texturing. Chamber 250 may be a reactive ion etch (RIE) chamber for etching the front surface of layer 210. Chamber 250 may utilize gases such as CF4, CHF3, etc. and may also utilize argon gas to enhance physical etching. The texturing produced in chamber 250 is random when no mask is provided over the layer 110, or it may be patterned when a mask is provided.

Once the front surface of layer 110 has been texturized, the glass substrate 205 is moved into chamber 255, wherein a DLC layer 115 is deposited. Chamber 255 may be a PVD sputtering chamber.

According to further embodiments, the texturization of layer 110 is done using wet etching, rather than RIE. Using wet etching technique without a mask, the silicon dioxide can be etched so as to form pyramids. The pyramids act to reduce reflection of light. The remainder of the process is as described above. However, for wet etching the substrate must exit the vacuum environment.

According to other embodiments the texturization is performed so as to form a patterned, rather than random, texture. According to one embodiment, this is done using photoresist masking. In one embodiment, a photoresist is deposited over the front surface of the glass substrate using, e.g., spin-coat technique. Then nano-imprint lithography (NIL) is used to physically transfer a pattern onto the photoresist. The photoresist is then developed and so as to leave the pattern on the front surface of the glass substrate. The front surface is then etched using either dry (RIE) or wet etch.

According to one embodiment the patterning is done to generate high aspect ratio columnar structures, as illustrated in the callout in FIG. 1. Such structures also provide a hydrophobic surface, which helps in reducing finger prints on touch screens. According to another embodiment the patterning is done to generate high aspect holes, as illustrated in FIG. 4. In one embodiment, a first layer 410 of SiO2 is deposited on the front surface of the glass substrate 405 to a thickness of, e.g. 400-500 nm. Then a photoresist is spread over the SiO2 layer (not shown in FIG. 4). NIL is used to generate a pattern of holes having 300 nm diameter with pitch (distance from center of one hole to the next) of 700 nm, and is then UV developed. Then a wet etch process, e.g., using BHF solution is used to etch the holes' pattern to generate holes 460 having 300 nm diameter and 250 nm deep, with pitch (distance from center of one hole to the next) of 700 nm. Once etching is completed the remaining resist is striped, resulting in the structure shown in FIG. 4. Note that in FIG. 4 the holes are depicted as conical with slanted walls, due to the use of wet etching. In such a case the diameter at the bottom of the holes is larger than the diameter of the holes in the photoresist. When RIE etching is used, the holes can be made to have cylindrical shape with vertical walls. Then the resulting surface is coated with 10 nm of SiON, which is very hard and resists scratches. Thereafter, a layer of 3 nm DLC is deposited over the SiON layer (not shown in FIG. 4). The resulting glass has a scratch resistant surface and is hydrophobic, and is anti-reflective.

According to one embodiment, a coated glass for electronic devices is fabricated using various processes implemented by selecting from the following process steps, exemplified in FIG. 3. A glass substrate is first cleaned in step 300 using, e.g., wet clean, plasma dry clean, or a combination of wet and dry cleaning processes. Also a rinse in DI water can be included. After the front surface of the glass substrate is cleaned, the front surface is coated with a silicon-based transparent layer in step 302. In one embodiment, the transparent layer is SiO2, while in others it may be SiN3 or SiON. While SiN3 and SiON are more scratch resistant than SiO2, the SiO2 is easier to etch. The transparent layer in this particular example is made of silicon-oxide, SiO2, which can be deposited using, e.g., chemical vapor deposition, plasma enhanced chemical vapor deposition, etc. Gases such as silane and oxygen may be used to deposit the SiO2 layer.

In the next step 304, a photoresist film is deposited over the silicon-based transparent layer. In step 306 the photoresist is patterned using, e.g., NIL patterning process. Once the photoresist is patterned, the process proceeds either to dry texturing 308 or to wet texturing 318. If dry texturing 308 is chosen, it can be done using, e.g., an RIE plasma chamber having precursor gas, such as CF4, CHF3, etc. While in some embodiments the texturization may be random, in this example the texturing is patterned, i.e., non-random, by the use of the patterned photoresist. In step 309 the remaining photoresist is stripped. If needed, after the photoresist strip the texturized front surface of the transparent layer may then be cleaned at step 315. The process done thus far forms the anti-reflective coating (ARC layer) over the front surface of the glass substrate. This anti-reflective coating is also inherently hydrophobic.

In one optional example, in order to increase the scratch resistance of the coated glass, at step 322 a hardening process is performed. The hardening process according to one particular example is done by depositing a thin-film layer of SiN3 or SiON over the texturized surface of the transparent layer. This is illustrated in FIG. 5, wherein layer 522 is deposited over the textured surface of SiO2 layer 510. The DLC layer 515 is deposited over the hardening layer 522. According to one example, the SiN3 or SiON hardening layer has a thickness of from 5 nm to 30 nm. In one specific example the thickness of the SiN3 or SiON layer is 10 nm.

According to another hardening example, nitrogen atoms and/or ions are implanted into the textured ARC layer. This may be done using plasma immersion, using remote plasma implant, or using ion beam. Regardless of the implant method used, the resulting structure is different from the case wherein the ARC layer is formed using SiON. When forming the ARC layer using deposition of SiON, the resulting structure is a layer of crystalline film having silicon, oxygen and nitrogen atoms forming the crystallographic structure. Conversely when forming the ARC layer using SiO2, followed by nitrogen implant, the resulting structure is a crystallographic SiO2, with nitrogen atoms and/or ions randomly implanted within the crystallographic SiO2, and at time amorphizing the crystallographic structure, thus introducing stress, which increases the scratch resistance of the ARC layer.

Regardless of the path taken thus far, as shown in FIG. 3, in order to further enhance the anti-scratch property of the glass, in step 311 a DLC layer is formed over the ARC or SiON layer. The DLC layer may be formed using any standard technique, such as physical vapor deposition (sputtering). The DLC layer may have a thickness of 2-20 nm. In the case where the SiON layer has thickness of 10 nm or more, the thickness of the DLC may be kept very thin, such as 3-5 nm.

It has been discovered that by providing the texture on the front surface of the transparent layer, the coated glass exhibits improved hydrophobic, i.e., anti-finger printing, property. Accordingly, in some embodiments there is no requirement or need to provide an anti-finger printing coating over the DLC. Of course, if desired, any of the disclosed embodiments may be modified by adding an anti-finger printing layer, such as FAS (fluoroalkylsilane), over the DLC, to further enhance the anti-finger printing property of the coated glass. This is shown as optional step 313 and optional layer 513.

It should be understood that processes and techniques described herein are not inherently related to any particular apparatus and may be implemented by any suitable combination of components. Further, various types of general purpose devices may be used in accordance with the teachings described herein. The present invention has been described in relation to particular examples, which are intended in all respects to be illustrative rather than restrictive. Those skilled in the art will appreciate that many different combinations will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

1. A coated glass for electronic devices, comprising:
a glass substrate defining a front surface facing a user;
a silicon-based thin film coating applied over and in direct contact with the front surface and having a textured surface facing away from the front surface; and,
a diamond-like coating (DLC) applied over the textured surface.

2. The coated glass of claim 1, wherein the silicon-based thin film comprises one of: silicon dioxide, silicon nitride and silicon oxy-nitride.

3. The coated glass of claim 1, wherein the silicon-based thin film comprises silicon dioxide.

4. The coated glass of claim 3, further comprising a silicon oxy-nitride (SiON) thin-film applied between the silicon-based thin film and the DLC.

5. The coated glass of claim 4, wherein the SiON thin-film has a thickness of 5 nm to 30 nm and the DLC has a thickness of 2-20 nm.

6. The coated glass of claim 3, wherein the silicon-based thin film further comprises nitrogen atoms implanted into the silicon oxide.

7. The coated glass of claim 1, wherein the textured surface is patterned.

8. The coated glass of claim 1, wherein the textured surface comprises etched pyramids.

9. The coated glass of claim 1, wherein the textured surface comprises etched columnar pillars.

10. The coated glass of claim 1, wherein the textured surface comprises etched holes.

11. The coated glass of claim 10, wherein the holes have a diameter of from 150 nm to 450 nm.

12. The coated glass of claim 11, wherein the holes have a depth of from 150 nm to 350 nm.

13. The coated glass of claim 11, wherein the holes have a pitch of from 500 nm to 900 nm.

14. The coated glass of claim 1, further comprising a layer of FAS coated over the DLC.

15. A method for fabricating a cover glass for electronic devices, comprising the steps:
i. forming a silicon-based thin-film coating over a front surface of a glass substrate;
ii. texturing the thin-film coating to thereby form an anti-reflective coating (ARC) layer having a textured surface;
iii. depositing a diamond-like coating (DLC) over the textured surface.

16. The method of claim 15, further comprising, between steps i. and ii., coating the textured surface with photoresist layer and patterning the photoresist layer, and after step ii., further comprising a step of stripping the photoresist layer.

17. The method of claim 15, further comprising, between steps i. and ii., including a step of hardening the ARC layer.

18. The method of claim 17, wherein hardening the ARC layer comprises implanting nitrogen atoms or ions into the ARC layer.

19. The method of claim 17, wherein hardening the ARC layer comprises forming a SiON layer over the ARC layer.

20. The method of claim 15, further comprising forming an FAS layer over the DLC.
